(19) United States
(12) Patent Application Publication
(10) Pub. No.: US 2017/0147203 A1
(43) Pub. Date: May 25, 2017

(54) APPARATUS, METHOD, AND PROGRAM FOR A SOFTWARE KEYBOARD DISPLAY

(71) Applicant: LENOVO (Singapore) PTE. LTD., New Tech Park (SG)

(72) Inventor: Hiroshi Itoh, Sagamihara-shi (JP)

(21) Appl. No.: 15/361,307

(22) Filed: Nov. 25, 2016

(30) Foreign Application Priority Data
Nov. 25, 2015 (JP) 2015-229719

(51) Int. Cl. G06F 3/0488

(52) U.S. Cl. CPC G06F 3/04886; G06F 2203/04803

(57) ABSTRACT

An apparatus is disclosed. The apparatus may include a first image display that may include a touch panel that displays a first image. The apparatus may include an image display control unit that may display a second image in a second image display. The first image may include an image different from the second image. The apparatus may include a keyboard display control unit that may selectively display, on the first image display, a first software keyboard and a second software keyboard. The second software keyboard may be larger in size than the first software keyboard. In response to the image display control unit displaying, in the second image display, the second image, the keyboard display control unit may selectively display the second software keyboard on the first image display. A method and program product are also disclosed.

### FIELD

The subject matter disclosed herein relates to a software keyboard an apparatus, method, and program for a software keyboard display.

### BACKGROUND

Recently, portable computing apparatuses such as tablet personal computers (hereinafter called “tablets”), smartphones, personal digital assistants (PDAs), and electronic book browsing terminals have become widely available. Many of these portable computing apparatuses include touch panels as image display units, which may include touch screens. A portable computing apparatus may use a software keyboard, also called an on screen keyboard (OSK). The software keyboard may enable input processing with operations to input keys displayed on a touch panel.

In some cases, the software keyboard covers a material of the screen of the touch panel. This may make it hard to see other displayed information. In some cases, the software keyboard may be small as to not cover too much of the display area of the touch panel. This may make it difficult for a user to touch a desired key of the software keyboard without touching other keys or to see the desired key because of the small size.

### SUMMARY

An apparatus is disclosed. In one embodiment, the apparatus may include a first image display that may include a touch panel that displays a first image. The apparatus may include an image display control unit that displays a second image in a second image display. The first image may include an image different from the second image. The apparatus may include a keyboard display control unit. The keyboard display control unit may selectively display, on the first image display, a first software keyboard, and a second software keyboard. The second software keyboard may be larger in size than the first software keyboard. In one embodiment, in response to the image display control unit displaying, in the second image display, the second image, the keyboard display control unit may selectively display the second software keyboard on the first image display.

In some embodiments, the second software keyboard may include more types of input keys than the first software keyboard. In one embodiment, in response to the image display control unit displaying, in the second image display, the second image and the first image display displaying the first software keyboard, the keyboard display control unit may switch the first software keyboard displayed on the first image display to the second software keyboard.

In one embodiment, in response to a predetermined operation to the first image display, the keyboard display control unit may switches between the first software keyboard and the second software keyboard displayed on the first image display. In some embodiments, the second software keyboard may include at least one input key group, wherein each input key group comprises multiple input keys of a same type. In one embodiment, the first software keyboard may be free of numeric keys and the second software keyboard may include numeric keys. In some embodiments, a layout of the second software keyboard may include a customizable layout.

A method is disclosed. In one embodiment, the method may include displaying a first image on a first image display. In one embodiment, the method may include displaying a second image on a second image display. In some embodiments, the method may include selectively displaying, on the first image display, a first software keyboard and a second software keyboard. The second software keyboard may be larger in size than the first software keyboard. The first image display may display the second software keyboard in response to the second image comprising an image different from the first image.

In one embodiment, the second software keyboard being larger in size than the first software keyboard may include the second software keyboard comprising more types of input keys than the first software keyboard. In some embodiments, the method may further include, in response to the second image display displaying the second image and the first image display displaying the first software keyboard, switching the first software keyboard displayed on the first image display to the second software keyboard.

In one embodiment, the method may include, in response to a predetermined operation to the first image display, switching between the first software keyboard and the second software keyboard. In one embodiment, displaying the second software keyboard may include displaying at least one input key group. Each input key group may include multiple input keys of a same type. In one embodiment, displaying the first software keyboard may include displaying a keyboard free of numeric keys and displaying the second software keyboard may include displaying numeric keys. In one embodiment, the method may include displaying a layout of the second software keyboard. The layout may include a customizable layout.

A program product is disclosed. The program product may include a computer readable storage medium. The medium may store code executable by a processor. The code may include code to perform displaying a first image on a first image display. The code may include code to perform displaying a second image on a second image display. The code may include code to perform selectively displaying, on the first image display, a first software keyboard and a second software keyboard. In one embodiment, the second software keyboard may be larger in size than the first software keyboard. In certain embodiments, the first image display may display the second software keyboard in response to the second image including an image different the first image.

In one embodiment, the code to perform displaying the second software keyboard may include code to perform displaying more types of input keys than the first software keyboard. In one embodiment, the code may include code to perform, in response to the second image display displaying the second image and the first image display displaying the first software keyboard, switching the first software keyboard displayed on the first image display to the second software keyboard. In one embodiment, the code may include code to perform, in response to a predetermined operation to the first image display, switching between the first software keyboard and the second software keyboard.

In some embodiments, the code to perform displaying the second software keyboard may include code to perform displaying at least one input key group. Each input key group may include a multiple input keys of a same type. In one embodiment, the code to perform displaying the first software keyboard may include code to perform displaying a keyboard free numeric keys and displaying the second software keyboard may include displaying numeric keys.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, embodiments will be described and explained with additional specificity and detail through the use of the accompanying drawings, in which:

FIG. 1 is a front view diagram illustrating one embodiment of an apparatus;

FIG. 2 is a schematic block diagram illustrating one embodiment of a hardware configuration of an apparatus;

FIG. 3 is a layout diagram illustrating one embodiment of software keyboards;

FIG. 4 is a schematic block diagram illustrating one embodiment of a keyboard display function of an apparatus;

FIG. 5 is a front view diagram illustrating one embodiment of a state of displaying a full OSK on a touch panel of an apparatus;

FIG. 6 is a schematic block flowchart illustrating one embodiment of a method; and

FIG. 7 is a schematic block diagram illustrating another embodiment of a hardware configuration of an apparatus.

### DETAILED DESCRIPTION

Several embodiments of an apparatus, method, and a program for a software keyboard display will be described below with reference to the accompanying drawings.

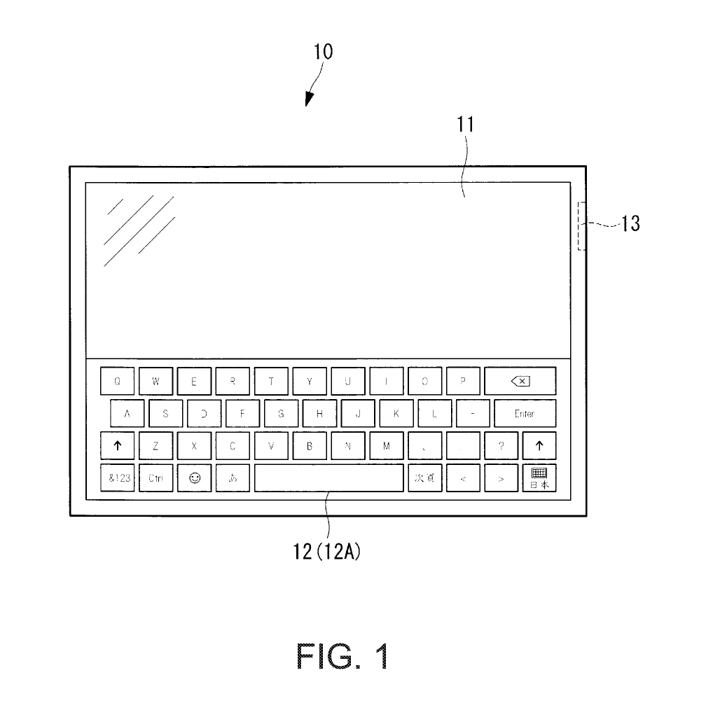

FIG. 1 is a front view diagram illustrating one embodiment of an apparatus 10. The apparatus 10, in some embodiments, may include a tablet without any physical keyboard. The apparatus 10 may include an image display unit as a touch panel 11. The image display unit as a touch panel 11 may include a touch screen.

A user of the apparatus 10 may operate the apparatus 10 through the touch panel 11. For example, in response to the user performing character input, the touch panel 11 may display a software keyboard 12 to perform character input through the software keyboard 12. In some embodiments, the software keyboard 12 may include an OSK (On Screen Keyboard).

The apparatus 10 may display images in an image display area different from the touch panel 11. This image display area may include another apparatus such as a portable computing apparatus, a liquid crystal display (LCD), a screen on which the images are projected by a projector, or the like.

The apparatus 10 may include an external port 13, such as a universal serial bus (USB) port, a display port such as a video graphics array (VGA) or HIGH-DEFINITION MULTIMEDIA INTERFACE (HDMI) port, or the like, on a side face as an external output terminal. The external port 13 may be used, for example, in response to another device (hereinafter called an “external image display”) connecting to the apparatus 10 to display images externally or the like. In some embodiments, the apparatus 10 may display images received through wireless transmission such as Wi-Fi, BLUETOOTH, or the like.

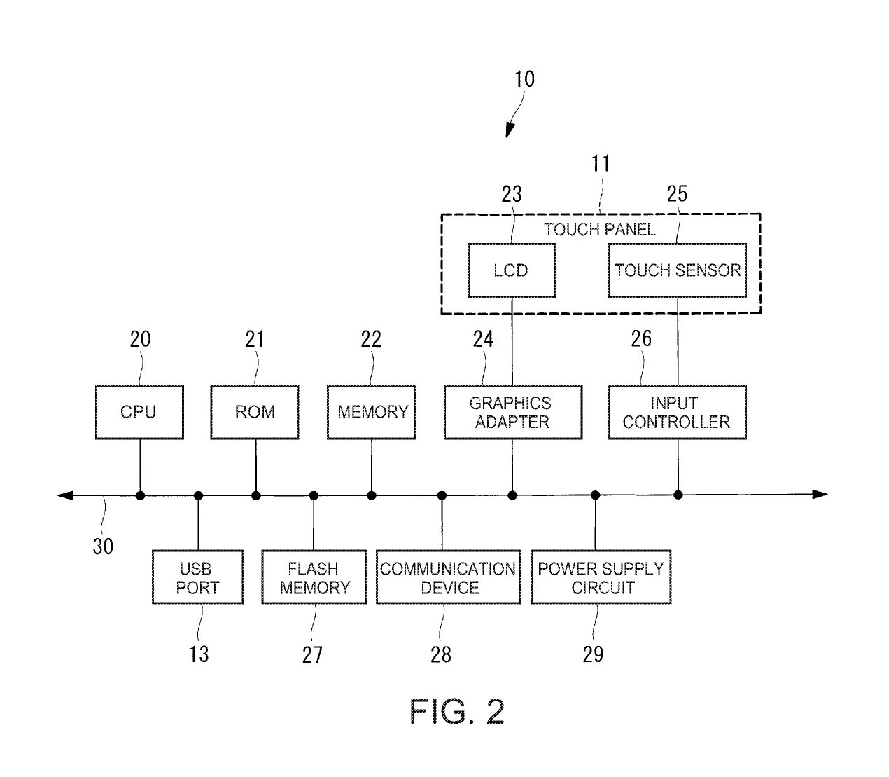

FIG. 2 is a schematic block diagram illustrating one embodiment of a hardware configuration of the apparatus 10. The apparatus 10 may include a central processing unit (CPU) 20, a read only memory (ROM) 21, a memory 22, an LCD 23, a graphics adapter 24, a touch sensor 25, an input controller 26, a flash memory 27, a communication device 28, a power supply circuit 29, and the external port 13 mentioned above, where respective units may connect directly or indirectly through a bus 30. The touch panel 11 may be configured to include the LCD 23 and the touch sensor 25.

The CPU 20 may control at least a portion of the apparatus 10 using an operating system stored in the ROM 21, memory 22, flash memory 27, or the like connected through the bus 30. The CPU 20 may perform processing based on various programs stored in the ROM 21, memory 22, flash memory 27, or the like.

The ROM 21 may store a basic input/output system (BIOS), various data, or the like. The memory 22 may include a cache memory and a random access memory (RAM), which may include a writable memory used as a work area to read a program executed by the CPU 20 and write data processed by the execution program. The flash memory 27 may store an operating system (OS), such as WINDOWS, IOS, ANDROID, or the like to control at least a portion of the apparatus 10, various drivers to perform hardware operations on peripheral devices, applications for specific tasks, and various data and files. The apparatus 10 may include other memory units such as a hard disk drive (HDD).

The LCD 23 may display a video signal from the graphics adapter 24 as an image under the control of the CPU 20. The graphics adapter 24 may convert display information to a video signal and output the converted video signal to the LCD 23 under the control of the CPU 20.

The touch sensor 25 may include a capacitance type touch sensor to detect and output a user's touch position on the LCD 23 to the input controller 26. The touch sensor 25 may select screen objects, such as various menus, icons, buttons, and a software keyboard, displayed on the screen of the LCD 23 to carry out input operations, text input operations, and screen operations such as scroll and swipe. The touch panel 11 may include the LCD 23, the touch sensor 25, or the like. The input controller 26 may perform various processing by a processor executing a program stored in the ROM or the like to control the operation of the touch sensor 25.

The communication device 28 may control communication with other devices through a network. The communication device 28 may include a Wi-Fi adaptor, an Ethernet card, or the like.

The power supply circuit 29 may include an AC adapter, a battery, a charger used to charge the battery, a DC/DC converter, or the like to supply power to each device under the control of the CPU 20.

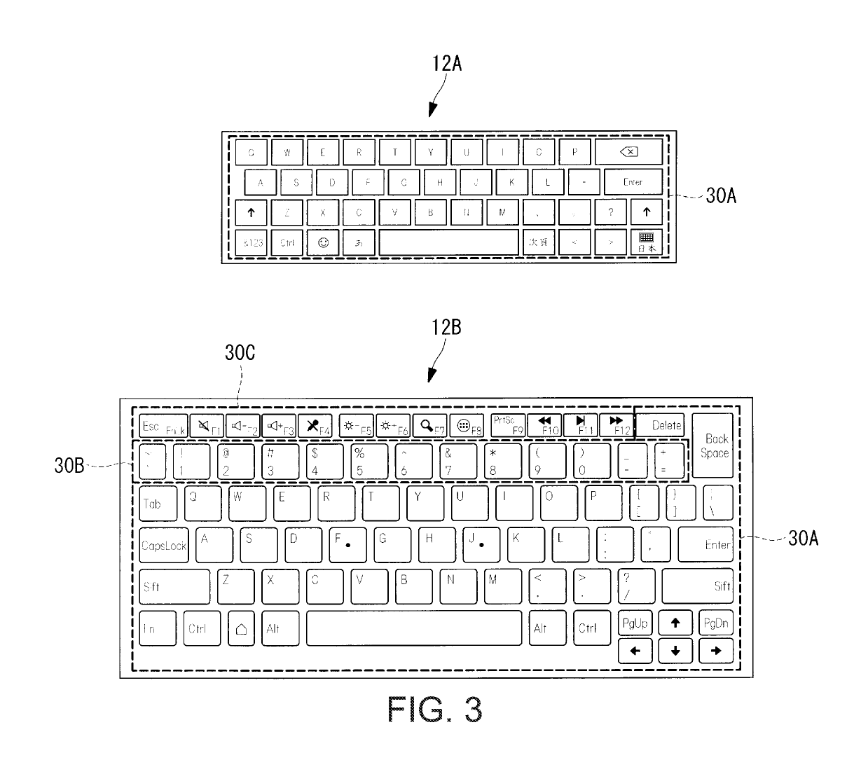

FIG. 3 is a layout diagram illustrating one embodiment of software keyboards. The apparatus 10 may include at least two kinds of layouts, namely a limited software keyboard (hereinafter called the “limited OSK”) 12A and a full software keyboard (hereinafter called the “full OSK”) 12B. Data indicative of the two kinds of layouts, i.e., the limited OSK 12A and the full OSK 12B, may be stored in the flash memory 27.

In one embodiment, a gathering of multiple input keys of the same type may be called an input key group. For example, an input key group may include a set of alphabetical keys containing A to Z, a set of numeric keys containing 0 to 9, and a set of function keys containing F1 to F12 or the like, The preceding input key groups may be called an alphabetical key group 30A, a numeric key group 30B, and a function key group 30C, respectively.

The limited OSK 12A may include a keyboard with limited types of input keys. On the limited OSK 12A, the alphabetical key group 30A may be displayed and the numeric key group 30B and the function key group 30C may not be displayed. In response to a numeric character being entered or input being performed to a function key on the limited OSK 12A, the layout of the limited OSK 12A may switch to display the numeric key group 30B or the function key group 30C.

The full OSK 12B may include multiple types of input keys compared with the limited OSK 12A. The full OSK 12B may include, for example, 97 keys or 101 keys. The function key group 30C may be displayed together with the numeric key group 30B as illustrated in FIG. 3. However, the layout of the full OSK 12B is not limited thereto.

Furthermore, the layout of the full OSK 12B may be changed. For example, the key arrangement of the full OSK 12B and the types of displayed keys may be customized for each user. The customized layout of the full OSK 12B may be stored in the flash memory 27. For example, in one embodiment, the full OSK 12B may include a layout that includes the numeric key group 30B displayed as a numeric keypad rather than that the numeric key group 30B arranged linearly above the alphabetical key group 30A. The position of this numeric keypad may be configured by the user. In some embodiments, in the full OSK 12B, one or more shortcut keys may be set by the user. Multiple special keys may be displayed as input key groups in addition to one or more input key groups.

In some embodiments, in response to being displayed on the touch panel 11, the full OSK 12B may include more input keys than the limited OSK 12A. For example, in one embodiment, individual keys of the limited OSK 12A and full OSK 12B may substantially identical in size. The overall size of the full OSK 12B may be relatively large. The proportion of the full OSK 12B to the overall display area of the touch panel 11 may be large. The full OSK 12B may occupy a larger area of the display area of the touch panel 11 than the limited OSK 12A. The term “occupy” here may include that the display size of the limited OSK 12A may be enough to perform touch typing easily, which may include, for example, a full screen display of the full OSK 12B.

On the other hand, in one embodiment, the limited OSK 12A may be smaller than the full OSK 12B. In response to the limited OSK 12A being displayed on the touch panel 11, the proportion of the limited OSK 12A to the display area of the touch panel 11 may be small. The proportion of the limited OSK 12A to the display area of the touch panel 11 may be small, as illustrated in FIG. 1. The smaller proportion may allow the apparatus 10 to display another image different from the limited OSK 12A at the same time.

The apparatus 10 may include a keyboard display function that selectively displays the limited OSK 12A and the full OSK 12B. As used herein, the term “selectively” may include that the apparatus 10 may switch between the limited OSK 12A and the full OSK 12B during runtime, in real time, or the like.

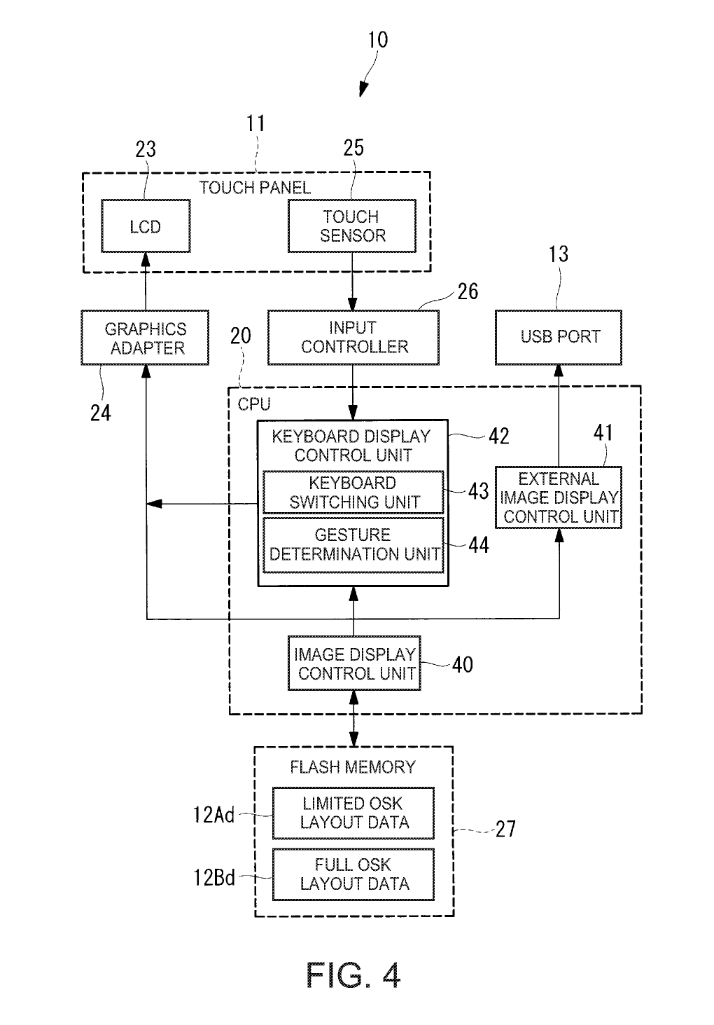

FIG. 4 is a schematic block diagram illustrating one embodiment of a keyboard display function of the apparatus 10.

In one embodiment, the flash memory 27 may store limited OSK layout data 12Ad. The limited OSK layout data 12Ad may be indicative of the layout of the limited OSK 12A. The flash memory 27 may store full OSK layout data 12Bd. The full OSK layout data 12Bd may be indicative of the layout of the full OSK 12B. In some embodiments, the OSK layout data 12Ad and/or 12Bd may be stored in a HDD or other storage medium.

In one embodiment, the CPU 20 may include an image display control unit 40, an external image display control unit 41, and/or a keyboard display control unit 42.

The image display control unit 40 may read, from the flash memory 27, image data indicative of an image to be displayed on the touch panel 11 or the external image display. The image display control unit 40 may output the image data to the graphics adapter 24, the external image display control unit 41, and/or the keyboard display control unit 42. The image data may be determined depending on the user's operation or the like.

In one embodiment, the external image display control unit 41 may output the image data. The external image display control unit 41 may receive the image data from the image display control unit 40. The external image display control unit 41 may output the image data to the external image display through the external port 13 to display the image on the external image display. The external image display control unit 41 may include a simultaneous display function that displays, on the external image display, the same image as that displayed on the touch panel 11. The external image display control unit 41 may include a function that displays, on the external image display, an image different from the image displayed on the touch panel 11.

In some embodiments, the keyboard display control unit 42 may include a function that selectively displays the limited OSK 12A and the full OSK 12B on the touch panel 11.

In certain embodiments, in response to the touch panel 11 displaying an image different from the image displayed on the external image display, the keyboard display control unit 42 may selectively display the full OSK 12B on the touch panel 11 as the software keyboard 12. The touch panel 11 may display an image in response to the image display control unit 40 outputting image data. The keyboard display control unit 42 may read the layout data on the full OSK 12B from the flash memory 27 to display the full OSK 12B on the LCD 23 through the graphics adapter 24.

In one embodiment, in response to the image different from the image displayed on the touch panel 11 not displaying on the external image display, the keyboard display control unit 42 may selectively display the limited OSK 12A on the touch panel 11 as the software keyboard 12. The keyboard display control unit 42 may read the layout data on the limited OSK 12A from the flash memory 27 to display the limited OSK 12A on the LCD 23 through the graphics adapter 24.

In some embodiments, the image different from the image displayed on the touch panel 11 may not display on the external image display in response to the external image display not being in a connected state to the external port 13. The image may not display on the external image display in response to the same image as that displayed on the touch panel 11 being simultaneously displayed on the external image display.

In one embodiment, the keyboard display control unit 42 may include a keyboard switching unit 43 and/or a gesture determination unit 44. In response to the external image display control unit 41 displaying, on the external image display, the image different from the image displayed on the touch panel 11 such that the touch panel 11 displays the limited OSK 12A, the keyboard switching unit 43 may switch the limited OSK 12A displayed on the touch panel 11 to the full OSK 12B.

In one embodiment, in response to the touch panel 11 detecting a predetermined operation (hereinafter called a “switching gesture”), the gesture determination unit 44 may switch between the limited OSK 12A and the full OSK 12B to be displayed on the touch panel 11. In some embodiments, in response to a predetermined switching gesture (e.g., a zoom-in gesture) and the limited OSK 12A being displayed on the touch panel 11, the gesture determination unit 44 may switch the displayed limited OSK 12A to the full OSK 12B. In response to a predetermined switching gesture (e.g., a zoom-out gesture) and the full OSK 12B being displayed on the touch panel 11, the gesture determination unit 44 may switch the displayed full OSK 12B to the limited OSK 12A. The switching gesture at the time of switching from the full OSK 12B to the limited OSK 12A may include the zoom-out gesture. The switching gesture at the time of switching from the limited OSK 12A to the full OSK 12B may include the zoom-in gesture. In some embodiments, the switching gestures may include a pair of gestures with opposite finger motion. The switching gestures are not limited to the zoom-out gesture and the zoom-in gesture. For example, the full OSK 12B and the limited OSK 12A may be switched with another pair of gestures such as gestures that include moving a finger to the left or right on the touch panel 11, gestures that include moving the finger up and down, or the like. In one embodiment, switching between the full OSK 12B and the limited OSK 12A may include the same gesture.

In some embodiments, the image display control unit 40, external image display control unit 41, a keyboard display control unit 42, keyboard switching unit 43, or gesture determination unit 44 may be in the form of a hardware-only embodiment, a software-only embodiment, or an embodiment of a combination of hardware and software. A hardware embodiment may include a processor (such as the CPU 20), a specialty processor, or the like. In some embodiments, the present disclosure may be in the form of a computer program product implemented on one or more computer usable storage media (including, but not limited to, disk storage, optical storage, flash memory, or the like) including computer usable program codes thereon.

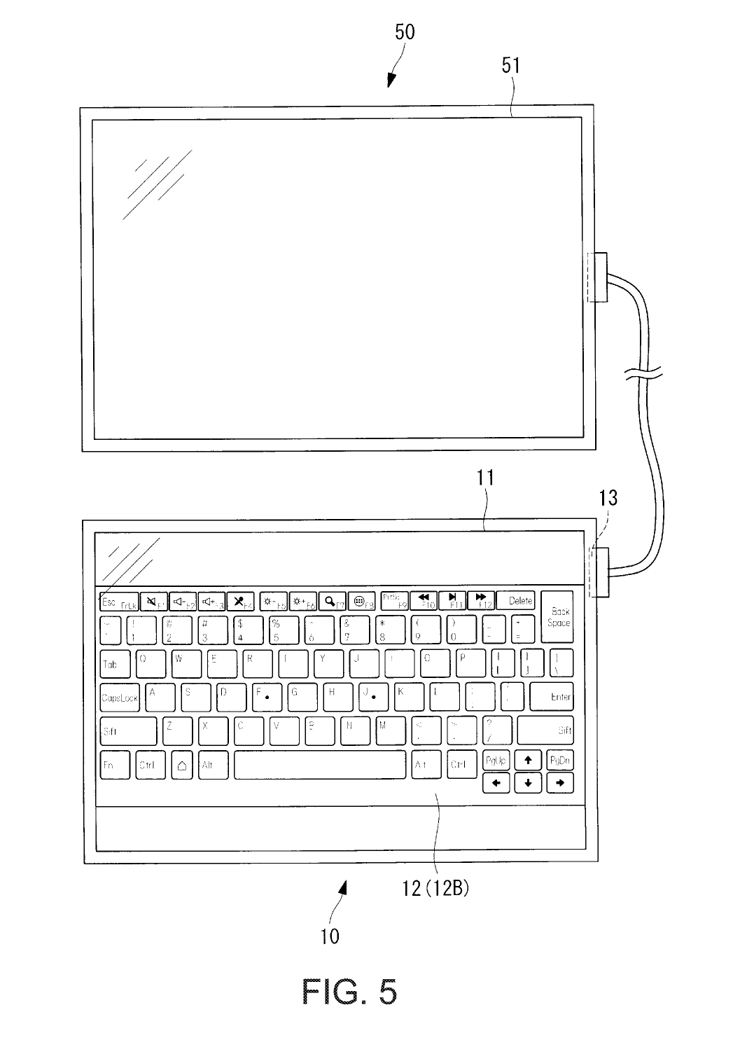

FIG. 5 is a front view diagram illustrating a one embodiment of the present disclosure. In some embodiments, an external image display may be connected to the apparatus 10 and the full OSK 12B may be displayed on the touch panel 11. In one embodiment, the external image display may include a tablet 50. The tablet 50 may be connected to the external port 13 of the apparatus 10. An image different from an image displayed on the touch panel 11 of the apparatus 10 may be displayed on a touch panel 51 as an image display area of this tablet 50. In certain embodiments, the full OSK 12B displayed on the touch panel 11 may occupy a larger area of the touch panel 11 than that of the limited OSK 12A. The numeric keys and/or the function keys may be displayed together with the alphabetical keys on the full OSK 12B. Thus, in some embodiments, the full OSK 12B may make it easy for the user to perform touch typing.

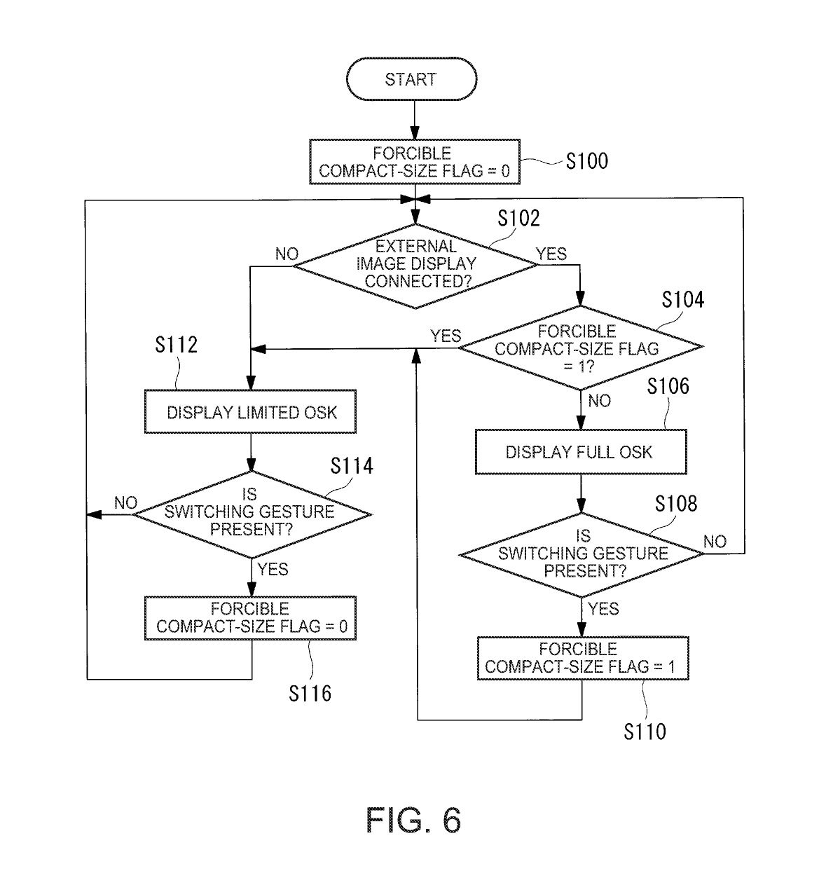

FIG. 6 is a schematic block flowchart illustrating a flow of keyboard display processing performed by the CPU 20 in response to the keyboard display function executing. A program related to the keyboard display processing may be stored in a predetermined area of the flash memory 27, HDD of the apparatus 10, or the like.

As illustrated in Table 1 below, switching between the limited OSK 12A and the full OSK 12B may be determined by a combination of the non-connected or connected state of the external image display and a forcible compact-size flag of “1” or “0.”

TABLE 1

| | Forcible compact-size | Forcible compact-size |
|---|---|---|
| State | flag = 0 | flag = 1 |
| External image display | Limited OSK | Limited OSK |
| is not connected | | |
| External image display | Full OSK | Limited OSK |
| is connected | | |

In response to the forcible compact-size flag being “0,” an image different from that displayed on the touch panel 11 may be displayed on the external image display. In response to the forcible compact-size flag being “1,” the same image as that displayed on the touch panel 11 may be displayed on the external image display, or no image may be displayed on the external image display.

In one embodiment, in step 100, the forcible compact-size flag may be set to “0.” In one embodiment, step 100 may execute in response to the apparatus 10 being powered on. In one embodiment, in step 102, it may be determined whether the external image display is connected to the external port 13. In response to determining that the external image display is connected to the external port 13, the procedure may proceed to step 104. In response to the external image display not being connected to the external port 13, the procedure may proceed to step 112.

In some embodiments, step 104 may include determining whether the forcible compact-size flag is “1.” In response to determining that the forcible compact-size flag is “1,” the procedure may proceed to step 112. In response to determining the forcible compact-size flag is “0,” the procedure may proceed to step 106.

In step 106, in response to the external image display being connected and the forcible compact-size flag being “0,” the full OSK 12B may be selected to set the full OSK 12B as the software keyboard 12 displayed on the touch panel 11. Thus, the full OSK 12B may be displayed on the touch panel 11 of the apparatus 10. This may enable the apparatus 10 to function as a device dedicated to the software keyboard. In some embodiments, the external image display may function as a monitor and the apparatus 10 as an input device for providing input to the apparatus 10. The external image display may display changes in response to that input. This may make it easy for a user to perform touch typing. In some embodiments, unlike the limited OSK 12A, there may be no need to switch the layout in response to the user performing numerical input on the full OSK 12B. Therefore, the user may not need to moves his or her fingers from the home positions when typing. In response to the user not moving his or her fingers from the home positions, the user may experience improved convenience using the software keyboard 12.

In one embodiment, step 108 may include determining whether a switching gesture is performed on the touch panel 11. In response to determining a switching gesture, the procedure may proceed to step 110. In response to not determining a switching gesture and/or detecting a gesture other than a switching gesture, the procedure may return to step 102.

In step 110, in one embodiment, the forcible compact-size flag may change from “0” to “1” and the procedure may proceed to step 112. In step 112, the limited OSK 12A may be set as the software keyboard 12 to be displayed on the touch panel 11. In certain embodiments, in response to the procedure moving from step 102 to step 112, the external image display may not be connected, the forcible compact-size flag may be “0,” and the limited OSK 12A may be displayed on the touch panel 11. In response to the procedure moving from step 110 to step 112, the forcible compact-size flag may be “1” even though the external image display may be connected, the limited OSK 12A may be selected, and the full OSK 12B displayed on the touch panel 11 may switch to the limited OSK 12A.

In one embodiment, step 114 may include determining a switching gesture performed on the touch panel 11. In response to determining a switch gesture, the procedure may proceed to step 116. In response to not determining a switch gesture, the procedure returns to step 102.

In step 116, the forcible compact-size flag may be set to “0” and the procedure may return to step 102. In some embodiments, in response to a switching gesture and the apparatus 10 being in a state where the external image display is connected and the limited OSK 12A is displayed, the procedure may proceed to step 106. In certain embodiments, the procedure may proceed to step 106 in response to step 114, step 116, step 102, and step 104 to switch from the limited OSK 12A to the full OSK 12B. In some embodiments, step 114, step 116, step 102, and step 104 may process in that order. In some embodiments, the steps may process in a different order. In certain embodiments, even when a switching gesture is performed in response to the external image display not being connected and the limited OSK 12A being displayed, step 114, step 116, step 102, and step 112 may be executed the software keyboard 12 may be displayed on the touch panel 11 as the limited OSK 12A.

As described above, in some embodiments, in response to an image different from an image displayed on the touch panel 11 being displayed on the external image display, the apparatus 10 may selectively display the full OSK 12B larger in size than the limited OSK 12A on the touch panel 11 as the software keyboard 12. Thus, in some embodiments, in response to the external image display displaying an image different from an image displayed on the touch panel 11, the apparatus 10 may improve the convenience of the software keyboard 12.

While the present disclosure has been described with reference to the aforementioned embodiments, the technical scope of the present disclosure is not limited to the scope of the aforementioned embodiments. Various changes or modifications can be added to the aforementioned embodiments without departing from the scope of the disclosure. Forms to which such changes or modifications are added are included in the technical scope of the present disclosure. Further, the aforementioned embodiments can be combined. For example, the full OSK 12B may include many types of input keys as the software keyboard 12.

In response to the external image display displaying an image, the apparatus 10 may set, as the software keyboard 12 displayed on the touch panel 11, a software keyboard whose layout is the same as a software keyboard when no image is displayed on the external image display and/or whose size is enlarged to occupy a wider display area of the touch panel 11. In one embodiment, such a form that an image is displayed on the external image display connected to the apparatus 10 through the external port 13 has been described, but the present invention is not limited thereto.

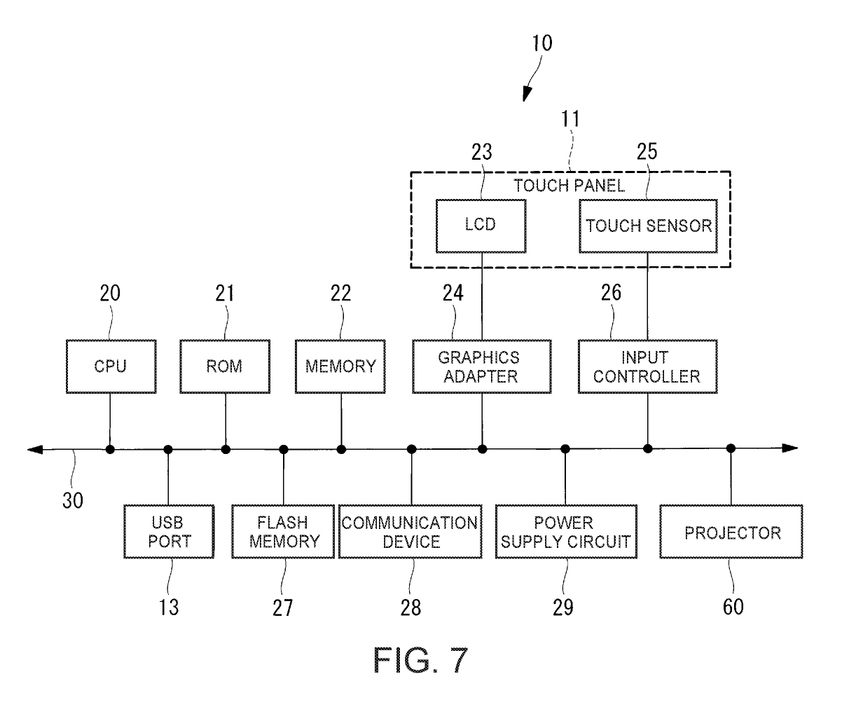

For example, as illustrated in FIG. 7, a projector 60 may be incorporated in the apparatus 10 so that a screen on which this projector 60 projects an image will be set as the image display area. In this form, the external image display control unit 41 outputs, to the projector 60, image data stored in the flash memory 27 without passing through the external port 13. Then, the keyboard display control unit 42 displays the full OSK 12B on the touch panel 11 of the apparatus 10.

In some embodiments, the apparatus 10 may include two touch panels 11. In this form, when different images are displayed on the two touch panels 11, respectively, the keyboard display control unit 42 displays the full OSK 12B on one of the touch panels 11.

The flow of the keyboard display processing described in the aforementioned embodiment is also an example, and an unnecessary step may be deleted, a new step may be added, or processing order may be changed without departing from the gist of the present invention.

For example, such a form that switching between the limited OSK 12A and the full OSK 12B is determined by the connected state of the external image display in combination of the forcible compact-size flag has been described in the keyboard display processing according to the embodiment, but the present invention is not limited thereto.

For example, switching between the limited OSK 12A and the full OSK 12B may be made by any other processing without using the forcible compact-size flag.

What is claimed is:

1. An apparatus comprising:
a first image display comprising a touch panel that displays a first image;
an image display control unit that displays a second image in a second image display, wherein the first image comprises an image different from the second image; and
a keyboard display control unit that selectively displays, on the first image display, a first software keyboard and a second software keyboard, wherein the second software keyboard is larger in size than the first software keyboard,
wherein in response to the image display control unit displaying, in the second image display, the second image, the keyboard display control unit selectively displays the second software keyboard on the first image display.

2. The apparatus of claim 1, wherein the second software keyboard comprises more types of input keys than the first software keyboard.

3. The apparatus of claim 1, wherein in response to the image display control unit displaying, in the second image display, the second image and the first image display displaying the first software keyboard, the keyboard display control unit switches the first software keyboard displayed on the first image display to the second software keyboard.

4. The apparatus of claim 1, wherein in response to a predetermined operation to the first image display, the keyboard display control unit switches between the first software keyboard and the second software keyboard displayed on the first image display.

5. The apparatus of claim 1, wherein the second software keyboard comprises at least one input key group, wherein each input key group comprises a plurality of input keys of a same type.

6. The apparatus of claim 1, wherein the first software keyboard is free of a plurality of numeric keys and the second software keyboard comprises a plurality of numeric keys.

7. The apparatus of claim 1, wherein a layout of the second software keyboard comprises a customizable layout.

8. A method comprising:
displaying a first image on a first image display;
displaying a second image on a second image display; and
selectively displaying, on the first image display, a first software keyboard and a second software keyboard, wherein the second software keyboard is larger in size than the first software keyboard, and wherein the first image display displays the second software keyboard in response to the second image comprising an image different from the first image.

9. The method of claim 8, wherein the second software keyboard being larger in size than the first software keyboard comprises the second software keyboard comprising more types of input keys than the first software keyboard.

10. The method of claim 8, further comprising, in response to the second image display displaying the second image and the first image display displaying the first software keyboard, switching the first software keyboard displayed on the first image display to the second software keyboard.

11. The method of claim 8, further comprising, in response to a predetermined operation to the first image display, switching between the first software keyboard and the second software keyboard.

12. The method of claim 8, wherein displaying the second software keyboard comprises displaying at least one input key group, wherein each input key group comprises a plurality of input keys of a same type.

13. The method of claim 8, wherein displaying the first software keyboard comprises displaying a keyboard free of a plurality of numeric keys and displaying the second software keyboard comprises displaying a plurality of numeric keys.

14. The method of claim 8, further comprising displaying a layout of the second software keyboard, wherein the layout comprises a customizable layout.

15. A program product comprising a computer readable storage medium that stores code executable by a processor, the code comprising code to perform:
displaying a first image on a first image display;
displaying a second image on a second image display; and
selectively displaying, on the first image display, a first software keyboard and a second software keyboard, wherein the second software keyboard is larger in size than the first software keyboard, and wherein the first image display displays the second software keyboard in response to the second image comprising an image different the first image.

16. The program product of claim 15, wherein the code to perform displaying the second software keyboard comprises code to perform displaying more types of input keys than the first software keyboard.

17. The program product of claim 15, further comprising code to perform, in response to the second image display displaying the second image and the first image display displaying the first software keyboard, switching the first software keyboard displayed on the first image display to the second software keyboard.

18. The program product of claim 15, further comprising code to perform, in response to a predetermined operation to the first image display, switching between the first software keyboard and the second software keyboard.

19. The program product of claim 15, wherein the code to perform displaying the second software keyboard comprises code to perform displaying at least one input key group, wherein each input key group comprises a plurality of input keys of a same type.

20. The program product of claim 15, wherein code to perform displaying the first software keyboard comprises code to perform displaying a keyboard free of a plurality of numeric keys and displaying the second software keyboard comprises displaying a plurality of numeric keys.
